(19) United States
(12) Patent Application Publication
(10) Pub. No.: US 2020/0210212 A1
(43) Pub. Date: Jul. 2, 2020

(54) SYSTEMS, METHODS, STORAGE MEDIA, AND COMPUTING PLATFORMS FOR END USER PRE-INFERRED CONTEXT DRIVEN APPLICATIONS

(71) Applicants: Anshuman Mishra, Erie, CO (US); Divyam Mishra, Erie, CO (US)

(72) Inventors: Anshuman Mishra, Erie, CO (US); Divyam Mishra, Erie, CO (US)

(21) Appl. No.: 16/236,009

(22) Filed: Dec. 28, 2018

(51) Int. Cl. G06F 9/451; G06F 16/16; G06F 16/907; G06F 16/172

(52) U.S. Cl. CPC G06F 9/451; G06F 16/172; G06F 16/907; G06F 16/168

(57) ABSTRACT

Systems, methods, storage media, and computing platforms for end user pre-inferred context driven applications are disclosed. Exemplary implementations may: perform upfront analysis of the end user's pre-inferred context; retrieve end user pre-inferred context metadata and/or data as the initial read operation; render a user interface that displays end user pre-inferred context metadata and/or data; retrieve additional end user pre-inferred context metadata and/or data; render a superimposed user interface with additional end user pre-inferred context metadata and/or data.

### FIELD OF THE DISCLOSURE

The present disclosure relates to systems, methods, storage media, and computing platforms for end user pre-inferred context driven applications.

### BACKGROUND

Computer programs, such as web-based applications, can generate large amounts of data. Users may add new data or request access to stored data. It can be challenging to store data in a manner that allows the data to be efficiently accessed in response to requests to read the data.

### SUMMARY

For many software applications, not all data may require equal accessibility. In any given system, it can be reasonable to assume that at least half the data is rarely accessed. In some implementations, as much as 80% of stored data may be needed only occasionally. This situation can have great performance implications for traditional file systems that are not meant for handling a large number of unstructured data files.

In a software application, data can grow over a period of time. At any point in time, only a portion of the data (e.g., around 20% of the data) may be considered to be “hot” data that is actively being used by the application. The other 80% of data can be either “warm” or “cold” data, which can be referred to herein as “stale” data. This stale data can grow rapidly over time, and can occupy a lot of storage space, slowing down the system. Traditional fine-tuning techniques to keep a software application efficient can be complex and computationally intensive.

Hot data can be used more frequently to satisfy end-user requests. Applications frequently delete, post, put, or retrieve hot data. Warm data can be mainly used for reporting purposes after a certain period of time. Cold and stale data can be seldom requested by the enduser, and therefore can be a candidate for archival.

Systems that store both hot and stale data together can experience performance problems. With growth of unstructured data, such a traditional file system index may not be able to cope with the data growth. This disclosure provides a solution to this technical problem that can automatically identify stale (e.g., warm and cold) data and automatically push stale data out from the active file-system. This way, an application can operate on hot data, whereas reporting features can leverage off-line warm and cold data.

In addition, in traditional computer software systems, a user may enter an explicit input and the system may return an explicit output. For example, in a traditional search system an explicit input leads to a set of search records directly related to that input. In such cases, it becomes complex for a user to express the context with explicit input. In the best-case scenario, the user enters a string that closely resembles the context. Consequently, the user is expected to parse through a large dataset (e.g., the output) to locate the information that is expected from the search results. In such situations, a search system can be enhanced either by accepting explicit context from the end-user or improve the system to automatically infer the context from the user supplied explicit search. In either of these cases the search system still relies on the end user to parse a better filtered result set and locate desired information. This disclosure provides a search system with pre-inferred context to better match a user's search expectations. This pre-inferred context can either be known to the end user or can be observed by connecting two pieces of inter-related search information.

Furthermore, traditional software applications may present a user with a large data set and allow the end user to parse through the data to select relevant records. As read operations outnumber insert operations, this traditional approach can present a large amount of unused data to the end user and generates unwanted load on the software system. This disclosure provides techniques for using the improved granularity of read data as a basis to improve a given software system's performance, scalability, and usability. This can make use of upfront analysis of the user's context, as well as retrieval of an optimal combination of metadata and data as part of the read operation. This also facilitates designing a user interface that displays more relevant data, and less irrelevant data, to the end user.

One aspect of the present disclosure relates to a system configured for managing data files. The system may include one or more hardware processors configured by machine-readable instructions. The processor(s) may be configured to receive an itinerary creation request specifying a destination city and a date. The processor(s) may be configured to identify a retention policy for data records associated with the destination city. The processor(s) may be configured to calculate a retention period end date based on the retention policy. The processor(s) may be configured to format a file name according to a predetermined naming scheme. The file name may specify the destination city and the retention period end date. The processor(s) may be configured to create a file having the file name in a file system. The processor(s) may be configured to store a data record corresponding to the itinerary creation request in the file.

Another aspect of the present disclosure relates to a method for managing data files. The method may include receiving an itinerary creation request specifying a destination city and a date. The method may include identifying a retention policy for data records associated with the destination city. The method may include calculating a retention period end date based on the retention policy. The method may include formatting a file name according to a predetermined naming scheme. The file name may specify the destination city and the retention period end date. The method may include creating a file having the file name in a file system. The method may include storing a data record corresponding to the itinerary creation request in the file.

Yet another aspect of the present disclosure relates to a non-transient computer readable storage medium having instructions embodied thereon, the instructions being executable by one or more processors to perform a method for managing data files. The method may include receiving an itinerary creation request specifying a destination city and a date. The method may include identifying a retention policy for data records associated with the destination city. The method may include calculating a retention period end date based on the retention policy. The method may include formatting a file name according to a predetermined naming scheme. The file name may specify the destination city and the retention period end date. The method may include creating a file having the file name in a file system. The method may include storing a data record corresponding to the itinerary creation request in the file.

Still another aspect of the present disclosure relates to a system configured for managing data files. The system may include means for receiving an itinerary creation request specifying a destination city and a date. The system may include means for identifying a retention policy for data records associated with the destination city. The system may include means for calculating a retention period end date based on the retention policy. The system may include means for formatting a file name according to a predetermined naming scheme. The file name may specify the destination city and the retention period end date. The system may include means for creating a file having the file name in a file system. The system may include means for storing a data record corresponding to the itinerary creation request in the file.

Even another aspect of the present disclosure relates to a computing platform configured for managing data files. The computing platform may include a non-transient computer-readable storage medium having executable instructions embodied thereon. The computing platform may include one or more hardware processors configured to execute the instructions. The processor(s) may execute the instructions to receive an itinerary creation request specifying a destination city and a date. The processor(s) may execute the instructions to identify a retention policy for data records associated with the destination city. The processor(s) may execute the instructions to calculate a retention period end date based on the retention policy. The processor(s) may execute the instructions to format a file name according to a predetermined naming scheme. The file name may specify the destination city and the retention period end date. The processor(s) may execute the instructions to create a file having the file name in a file system. The processor(s) may execute the instructions to store a data record corresponding to the itinerary creation request in the file.

One aspect of the present disclosure relates to a system configured for managing data files. The system may include one or more hardware processors configured by machine-readable instructions. The processor(s) may be configured to identify a file in a file system. The processor(s) may be configured to parse a name of the file according to a predetermined naming scheme to determine a retention period end date associated with the file. The processor(s) may be configured to determine that a current date is later than the retention period end date associated with the file. The processor(s) may be configured to copy the file to a cloud storage system, based on the determination that the current date is later than the retention period end date associated with the file. The processor(s) may be configured to delete the file from the file system.

Another aspect of the present disclosure relates to a method for managing data files. The method may include identifying a file in a file system. The method may include parsing a name of the file according to a predetermined naming scheme to determine a retention period end date associated with the file. The method may include determining that a current date is later than the retention period end date associated with the file. The method may include copying the file to a cloud storage system, based on the determination that the current date is later than the retention period end date associated with the file. The method may include deleting the file from the file system.

Yet another aspect of the present disclosure relates to a non-transient computer readable storage medium having instructions embodied thereon, the instructions being executable by one or more processors to perform a method for managing data files. The method may include identifying a file in a file system. The method may include parsing a name of the file according to a predetermined naming scheme to determine a retention period end date associated with the file. The method may include determining that a current date is later than the retention period end date associated with the file. The method may include copying the file to a cloud storage system, based on the determination that the current date is later than the retention period end date associated with the file. The method may include deleting the file from the file system.

Still another aspect of the present disclosure relates to a system configured for managing data files. The system may include means for identifying a file in a file system. The system may include means for parsing a name of the file according to a predetermined naming scheme to determine a retention period end date associated with the file. The system may include means for determining that a current date is later than the retention period end date associated with the file. The system may include means for copying the file to a cloud storage system, based on the determination that the current date is later than the retention period end date associated with the file. The system may include means for deleting the file from the file system.

Even another aspect of the present disclosure relates to a computing platform configured for managing data files. The computing platform may include a non-transient computer-readable storage medium having executable instructions embodied thereon. The computing platform may include one or more hardware processors configured to execute the instructions. The processor(s) may execute the instructions to identify a file in a file system. The processor(s) may execute the instructions to parse a name of the file according to a predetermined naming scheme to determine a retention period end date associated with the file. The processor(s) may execute the instructions to determine that a current date is later than the retention period end date associated with the file. The processor(s) may execute the instructions to copy the file to a cloud storage system, based on the determination that the current date is later than the retention period end date associated with the file. The processor(s) may execute the instructions to delete the file from the file system.

One aspect of the present disclosure relates to a system configured for managing data files. The system may include one or more hardware processors configured by machine-readable instructions. The processor(s) may be configured to receive an itinerary creation request specifying a destination city and a travel date. The processor(s) may be configured to identify a file in a file system. The processor(s) may be configured to parse a name of the file according to a predetermined naming scheme to determine a retention period end date associated with the file. The processor(s) may be configured to determine that the travel date occurs before the retention period end date specified in the name of the file in the file system. The processor(s) may be configured to update the file to include a data record corresponding to the itinerary creation request, based on the determination that the travel date occurs before the retention period end date specified in the name of the file.

Another aspect of the present disclosure relates to a method for managing data files. The method may include receiving an itinerary creation request specifying a destination city and a travel date. The method may include identifying a file in a file system. The method may include parsing a name of the file according to a predetermined naming scheme to determine a retention period end date associated with the file. The method may include determining that the travel date occurs before the retention period end date specified in the name of the file in the file system. The method may include updating the file to include a data record corresponding to the itinerary creation request, based on the determination that the travel date occurs before the retention period end date specified in the name of the file.

Yet another aspect of the present disclosure relates to a non-transient computer readable storage medium having instructions embodied thereon, the instructions being executable by one or more processors to perform a method for managing data files. The method may include receiving an itinerary creation request specifying a destination city and a travel date. The method may include identifying a file in a file system. The method may include parsing a name of the file according to a predetermined naming scheme to determine a retention period end date associated with the file. The method may include determining that the travel date occurs before the retention period end date specified in the name of the file in the file system. The method may include updating the file to include a data record corresponding to the itinerary creation request, based on the determination that the travel date occurs before the retention period end date specified in the name of the file.

Still another aspect of the present disclosure relates to a system configured for managing data files. The system may include means for receiving an itinerary creation request specifying a destination city and a travel date. The system may include means for identifying a file in a file system. The system may include means for parsing a name of the file according to a predetermined naming scheme to determine a retention period end date associated with the file. The system may include means for determining that the travel date occurs before the retention period end date specified in the name of the file in the file system. The system may include means for updating the file to include a data record corresponding to the itinerary creation request, based on the determination that the travel date occurs before the retention period end date specified in the name of the file.

Even another aspect of the present disclosure relates to a computing platform configured for managing data files. The computing platform may include a non-transient computer-readable storage medium having executable instructions embodied thereon. The computing platform may include one or more hardware processors configured to execute the instructions. The processor(s) may execute the instructions to receive an itinerary creation request specifying a destination city and a travel date. The processor(s) may execute the instructions to identify a file in a file system. The processor(s) may execute the instructions to parse a name of the file according to a predetermined naming scheme to determine a retention period end date associated with the file. The processor(s) may execute the instructions to determine that the travel date occurs before the retention period end date specified in the name of the file in the file system. The processor(s) may execute the instructions to update the file to include a data record corresponding to the itinerary creation request, based on the determination that the travel date occurs before the retention period end date specified in the name of the file.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 shows a system configured for managing data files, in accordance with one or more implementations.

FIG. 2 shows a system configured for managing data files, in accordance with one or more implementations.

FIGS. 3-6 show example graphical user interfaces (GUIs) that can be used in connection with the systems of FIGS. 1 and 2.

FIG. 7 shows a flow chart of a method for managing data files, in accordance with one or more implementations

FIG. 8 shows a flow chart of a method for managing data files, in accordance with one or more implementations

FIG. 9 shows a flow chart of a method for managing data files, in accordance with one or more implementations.

### DETAILED DESCRIPTION

This disclosure provides systems and methods that can be used to create templates for, or “templatize,” data storage in a file system, so that stale data can be moved away from the active file system, while data migration remains agnostic to the application and end-users, without incurring a major performance penalty. A template can define how data files are named and organized in the file-system, as well as how data is arranged within individual files. Using such a template, a data cleanup module can easily understand how data is stored and can explore data fields that can be used to determine data temperature. Subsequently, this generic cleanup module can migrate stale data from an active file-system. This approach can also be easily applied to RDBMS, NoSQL databases, and object storage systems.

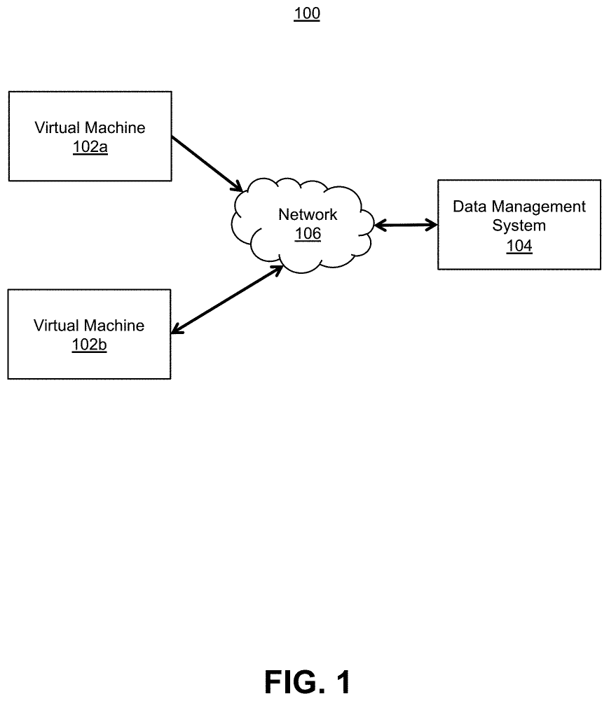

FIG. 1 shows a system 100 configured for managing data files, in accordance with one or more implementations. The system 100 includes two virtual machines 102a and 102b (sometimes referred to as virtual machines 102), and a data management system 104. The virtual machines 102a and 102b are communicatively coupled with the data management system 104 by a network 106. For example, the network 106 can be a local area network, a wide area network, or the Internet. The system 100 can be used to implement a companion marketplace in which prospective travel companions can enlist their help. For example, companion seekers can search for a suitable travel companion for their loved ones who may be travelling alone. This marketplace can help elderly people traveling between the US and non-English speaking countries of the world. For example, the marketplace can offer travel companion search for elderly people traveling between India and the United States.

The marketplace can be built using a two-tier architecture as shown in FIG. 1. For example, the two virtual machines 102a and 102b can each implement one of two web applications. The web application implemented by the virtual machine 102a can help international students or other travelers in enlisting their travel help by creating their travel itineraries. The second virtual machines 102b can implement a web application that helps users to find an international student or other traveler as a travel companion for their elderly loved ones travelling alone. In some implementations, both of these web applications may execute, for example, in two separate containers (e.g., Tomcat containers) on two separate cloud virtual machines 102a and 102b. The data management system 104 can implement a third cloud virtual machine that acts as a back-end server and hosts business logic. A sequential flat-file system can reside on the back-end server as a data store.

Selecting a sequential flat-file system as a data store may seem to be an odd choice. However, deploying a database for a small application may not be optimal. For example, a database may require performance tuning, regular backups and additional resources to perform regular database maintenance activities.

On the other hand, sequential flat files may not be ideal from a performance point of view. For example, backend business logic implemented by the data management system 104 can be written in Java or another object oriented programming language, and inherently tile inputs/outputs may therefore be relatively slow. There also may be restrictions on a maximum number of files that can be open at a given point of time. However, these limitations can be overcome by writing records (e.g., travel itineraries) into the files in an asynchronous manner using an Actor model (e.g., an Akka framework).

In some implementations, to speed up the read operations, the data management system 104 can employ an in-memory cache. A large number of read requests can be served from the cache and only a few operations may require reading data from the file system. This speeds-up retrieval of hot data. The file system can offer functionality such as creating a new file, deleting a given file, and inserting or deleting travel companion records from a given file.

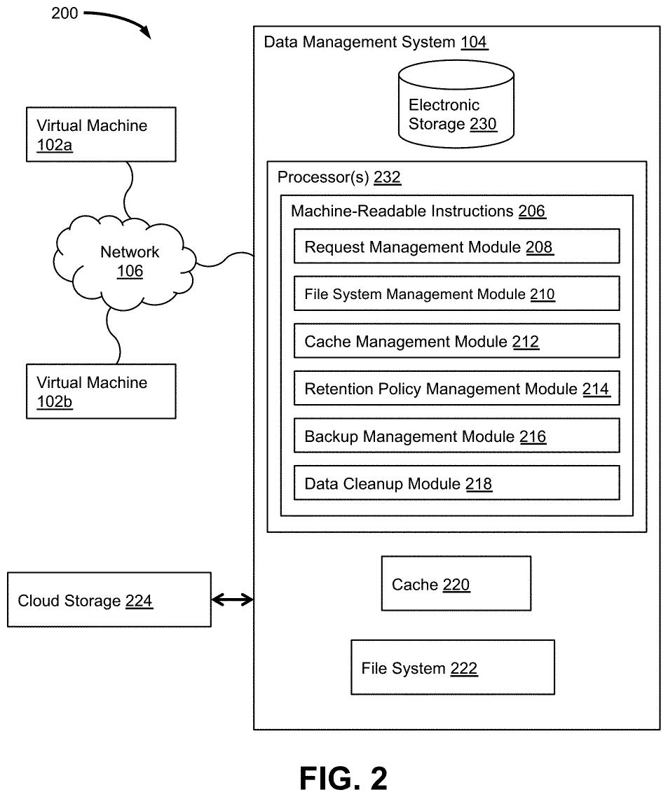

FIG. 2 illustrates a system 200 configured for managing data files, in accordance with one or more implementations. In some implementations, the system 200 can be or can include an instance of the system 100 shown in FIG. 1, or a subset of the components shown in the system 100. Like reference numerals in FIGS. 1 and 2 refer to like elements. In some implementations, system 200 may include one or more data management systems 104. Data management system 104 may be configured to communicate with one or more virtual machines 102 according to a client/server architecture and/or other architectures. Virtual machines 102a and 102b may be configured to communicate with other client computing platforms via data management system 104 and/or according to a peer-to-peer architecture and/or other architectures. Users may access system 200 via the virtual machines 102a and 102b (e.g., via the web applications implemented by the virtual machines 102a and 102b).

Data management system 104 may be configured by machine-readable instructions 206. Machine-readable instructions 206 may include one or more instruction modules. The instruction modules may include computer program modules. The instruction modules may include one or more of a request management module 208, a file system management module 210, a cache management module 212, a retention policy management module 214, a backup management module 216, a data cleanup module 218, and/or other instruction modules. The data management system 104 can also include a cache 220, a file system 222, and electronic storage 230. The system 200 can also include a cloud storage system 224 that is communicatively coupled with the data management system 104.

Using an actor model to handle write requests (e.g., put, post, delete) to manipulate data stored in the file system 222 in an asynchronous manner, and using the in-memory cache 220, can allow the travel companion marketplace to efficiently handle a large number of get, post, put, and delete requests simultaneously with high efficiency and reliability. This arrangement results in the system 200 being eventually consistent. In some implementations, it can be acceptable if an itinerary created by a prospective companion does not appear immediately in search results. This disclosure emphasizes an approach that can create a highly efficient and reliable sequential file system 222 which has the ability to self-monitor and clean out stale data efficiently.

The template system can be based on a data model used by the system 200. For example, in the travel companion marketplace, prospective travel companions may be able to create an itinerary between a US airport and any of eight major international airports in India. In some implementations, a template system may include one file stored in the file system 222 for each airport in India.

Since Java has a limit on how many file handles can be created on a per process basis, it can be useful to determine how to control the total number of files in the file system 222. For example, one important design consideration can be whether to create a large number of small files or a small number of large files. It can be assumed that a user can see and search travel companions for the next three months. Thus, creating one file per city per day would require 8*9 or 720 files total. This may be difficult or impossible for the file system to handle. Creating one file per city per quarter (e.g., the entire three month period) would require only eight files. However, each file would eventually store a large amount of cold data. Thus, there is a tradeoff between storing files for each city for long or short time periods.

In some implementations, it may be advantageous to avoid adopting a “one size fits all” policy for all cities. For example, depending on the inbound traffic to the airports in these cities, a city can have a file that can be created on a per-day, per-week, per-fortnight, per-month, or per-quarter basis. This information can be referred to as a “retention policy” for each airport or city.

Thus, in some implementations, a city having heavy traffic (e.g., New Delhi and Mumbai) may implement a retention policy in which one file per day is created. Other cities may have different retention policies depending on their traffic levels. For example, one file per city per week may be used for cities like Bangalore and Calcutta. One file per city per fortnight can be used for cities having moderate traffic like Hyderabad and Chennai. One file per city per month can be used for cities with less traffic like Ahmedabad and Trivandrum.

In some implementations, file names in the file system 222 can be created to include information relating to the destination city as well as the end date of the retention period for that city. In some implementations, files names may include the destination city with the end date timestamp appended. So for example, for a high traffic city such as New Delhi that may have a retention period of one day, a file for a 3-month period beginning on Aug. 1, 2018 could be “NewDelhi-08-01-2018”. For a lower traffic city such as Trivandrum that may have a retention period of one month, a file for a 3-month period beginning on Aug. 1, 2018 could be “Trivandrum-08-31-2018”.

When an itinerary creation request is received in the system 200, for example by the request management module 208, a file for the destination city can be created automatically if it does not already exist. To do so, the retention policy management module 216 can check the retention policy for the city and can determine the retention period. Subsequently, depending on the current date, the system calculates the retention period end date and appends it in the city name to formulate the file name. The file can be stored in the file system 222.

In some implementations, the cloud storage 224 can be used to store stale data. For example, the data cleanup module 218 can read the template and use the file name in the file system 222 to determine the temperature of a data files. Subsequently, the data cleanup module 218 scans the file system 22 and looks at the individual file names to find out if a day, end of the week, end of fortnight, or end of month date has elapsed (i.e., whether the current date is later than the date in the file name). If so, the data cleanup module 218 can determine that the data file is now stale (e.g., either cold or warm). Then the data cleanup module 218 can back up the warm/cold files from the file system 222 to cloud storage 224, and can delete the stale files from the file system 222.

This way the data cleanup module 224 helps in keeping only those files that contain hot data in the file system 222. Moving warm/cold data files from the file system 222 keeps the system healthy and optimal. Since the data cleanup module 222 works with the file names without opening them or scanning their content, it can quickly ascertain the temperature of individual files in the file system 222.

In an example, a prospective companion who is traveling to New Delhi from San Francisco on the 1st of August 2018 can create a travel itinerary using the web application provided by the virtual machine 102a. This itinerary can be stored on the back-end file system 222 in a file named NewDelhi-08-01-2018. This file may also contain other itineraries for several other travel companions who are going to New Delhi on Aug. 1, 2018.

This record can be searched by help seekers before Aug. 1, 2018. After August 1st, the record can become stale as the travel has taken place and users may no longer be interested in searching for this record. In this case, the record data (e.g., stale data) can be moved from the file system 222 to the cloud storage 224 by the data cleanup module 218. For example, a nightly job can activate the data cleanup module 218 in the early morning of August 2nd, and the file for New-Delhi-08-01-2018 can be moved to the cloud storage 224. This process keeps the server clean, fast, and efficient by removing stale data from the file system 222 and keeping the hot data in the back-end server.

Apart from keeping the old/cold/stale data on the cloud, a backup copy of the hot/active data in the file system 222 can also be stored on the cloud. For example, the backup management module 216 can store active or hot data in the cloud storage 224 on a periodic basis.

Thus, the system 200 can be configured to create a new file in the file system 222 and a new itinerary record, based on a request. For example, the request management module 208 may be configured to receive an itinerary creation request specifying a destination city and a date. Retention policy management module 214 may be configured to identify a retention policy for data records associated with the destination city. Retention policy management module 214 may be configured to calculate a retention period end date based on the retention policy. File system management module 210 may be configured to format a file name according to a predetermined naming scheme. The file name may specify the destination city and the retention period end date. File system management module 210 may be configured to create a file having the file name in a file system. File system management module 210 may be configured to store a data record corresponding to the itinerary creation request in the file. Cache management module 212 may be configured to store a copy of the file in a cache. Backup management module 216 may be configured to store a copy of the file in a cloud storage system remote from the file system. Request management module 208 may be configured to receive a read request associated with the file. Cache management module 212 may be configured to determine that the copy of the file is stored in the cache. Cache management module 212 may be configured to serve the copy of the file from the cache to fulfil the read request.

The system 200 can also be configured to actively monitor and clean data stored in the file system 222 to keep the file system 222 efficient. For example, the file system management module 210 may be configured to identify a file in a file system. Request management module 208 may be configured to parse a name of the file according to a predetermined naming scheme to determine a retention period end date associated with the file. Request management module 208 may be configured to determine that a current date is later than the retention period end date associated with the file. Data cleanup module 218 may be configured to copy the file to a cloud storage system, based on the determination that the current date is later than the retention period end date associated with the file. Data cleanup module 218 may be configured to delete the file from the file system. Data cleanup module 218 may be configured to delete the file from the file system without opening the file. Cache management module 212 may be configured to determine that a copy of the file exists in a cache. Data cleanup module 218 may be configured to delete the copy of the file from the cache. Request management module 208 may be configured to receive a read request associated with the file. Backup management module 216 may be configured to determine that the file is not stored in the file system. Backup management module 216 may be configured to serve the file from the cloud storage system to fulfil the read request.

In some implementations, the system 200 can also be configured to add new itinerary records to an existing file, based on a retention period for the file. For example, the request management module 208 may be configured to receive an itinerary creation request specifying a destination city and a travel date. File system management module 210 may be configured to identify a file in a file system. Request management module 208 may be configured to parse a name of the file according to a predetermined naming scheme to determine a retention period end date associated with the file. Request management module 208 may be configured to determine that the travel date occurs before the retention period end date specified in the name of the file in the file system. File system management module 210 may be configured to update the file to include a data record corresponding to the itinerary creation request, based on the determination that the travel date occurs before the retention period end date specified in the name of the file. Cache management module 212 may be configured to determine that a copy of the file exists in a cache. Cache management module 212 may be configured to update the copy of the file in the cache to include the data record corresponding to the itinerary creation request.

In some implementations, data management system 104, virtual machines 102a and 102b, and/or cloud storage 224 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which data management system 104, virtual machines 102a and 102b, and/or cloud storage 224 may be operatively linked via some other communication media.

A given virtual machine 102 may include one or more processors configured to execute computer program modules. The computer program modules may be configured to enable an expert or user associated with the given virtual machine 102 to interface with system 200 and/or cloud storage 224, and/or provide other functionality attributed herein to virtual machines 102a and 102b. By way of non-limiting example, the given virtual machine 102 may include one or more of a desktop computer, a laptop computer, a handheld computer, a tablet computing platform, a NetBook, a Smartphone, a gaming console, and/or other computing platforms.

Cloud storage 224 may include sources of information outside of system 200, external entities participating with system 200, and/or other resources. In some implementations, some or all of the functionality attributed herein to cloud storage 224 may be provided by resources included in system 200.

Data management system 104 may include electronic storage 230, one or more processors 132, and/or other components. Data management system 104 may include communication lines, or ports to enable the exchange of information with a network and/or other computing platforms. Illustration of data management system 104 in FIG. 2 is not intended to be limiting. Data management system 104 may include a plurality of hardware, software, and/or firmware components operating together to provide the functionality attributed herein to data management system 104. For example, data management system 104 may be implemented by a cloud of computing platforms operating together as data management system 104.

Electronic storage 230 may comprise non-transitory storage media that electronically stores information. The electronic storage media of electronic storage 230 may include one or both of system storage that is provided integrally (i.e., substantially non-removable) with data management system 104 and/or removable storage that is removably connectable to data management system 104 via, for example, a port (e.g., a USB port, a firewire port, etc.) or a drive (e.g., a disk drive, etc.). Electronic storage 230 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 230 may include one or more virtual storage resources (e.g., cloud storage, a virtual private network, and/or other virtual storage resources). Electronic storage 230 may store software algorithms, information determined by processor(s) 232, information received from data management system 104, information received from virtual machines 102a and 102b, and/or other information that enables data management system 104 to function as described herein.

Processor(s) 232 may be configured to provide information processing capabilities in data management system 104. As such, processor(s) 232 may include one or more of a digital processor, an analog processor, a digital circuit designed to process information, an analog circuit designed to process information, a state machine, and/or other mechanisms for electronically processing information. Although processor(s) 232 is shown in FIG. 2 as a single entity, this is for illustrative purposes only. In some implementations, processor(s) 232 may include a plurality of processing units. These processing units may be physically located within the same device, or processor(s) 232 may represent processing functionality of a plurality of devices operating in coordination. Processor(s) 232 may be configured to execute modules 208, 210, 212, 214, 216, and/or 218, and/or other modules. Processor(s) 232 may be configured to execute modules 208, 210, 212, 214, 216, and/or 218, and/or other modules by software; hardware; firmware; some combination of software, hardware, and/or firmware; and/or other mechanisms for configuring processing capabilities on processor(s) 232. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, and/or 218 are illustrated in FIG. 2 as being implemented within a single processing unit, in implementations in which processor(s) 232 includes multiple processing units, one or more of modules 208, 210, 212, 214, 216, and/or 218 may be implemented remotely from the other modules. The description of the functionality provided by the different modules 208, 210, 212, 214, 216, and/or 218 described below is for illustrative purposes, and is not intended to be limiting, as any of modules 208, 210, 212, 214, 216, and/or 218 may provide more or less functionality than is described. For example, one or more of modules 208, 210, 212, 214, 216, and/or 218 may be eliminated, and some or all of its functionality may be provided by other ones of modules 208, 210, 212, 214, 216, and/or 218. As another example, processor(s) 232 may be configured to execute one or more additional modules that may perform some or all of the functionality attributed below to one of modules 208, 210, 212, 214, 216, and/or 218.

In some implementations, the system 200 can implement a pre-inferred context to better match a user's search expectations. This pre-inferred context can either be known to the end user or can be observed by connecting two pieces of inter-related search information.

In traditional travel companion search systems, a search interface may allow a user to enter an origin city and a destination city, then select a search button. In this traditional search, the user provides an explicit search criterion such as “origin city” and “destination city.” The search system results in a set of records where prospective travel companion's itinerary matches with the given origin city and destination city. However, companion seekers may have a preferred departure date when they want a travel companion available at origin city, but travel companions may not always be available for a given day, or the available companions may not be a good fit for traveler (e.g., due to a cultural or linguistic background of the traveler). Given this situation, companion seekers may be willing to book their loved one's air travel to exactly match a preferred travel companion's travel itinerary (e.g., same day, same origin city, same airline, same stop-overs, etc.), even if it differs from their first choice of itinerary.

With this context in mind, a companion seeker may prefer to see a snapshot of companions available for a predetermined period of time, such as the next three months. For example, many travelers may book their international tickets two to three months in advance. This can help a companion seeker in figuring out the possible travel start days at their origin city during which one or more preferred travel companions are available.

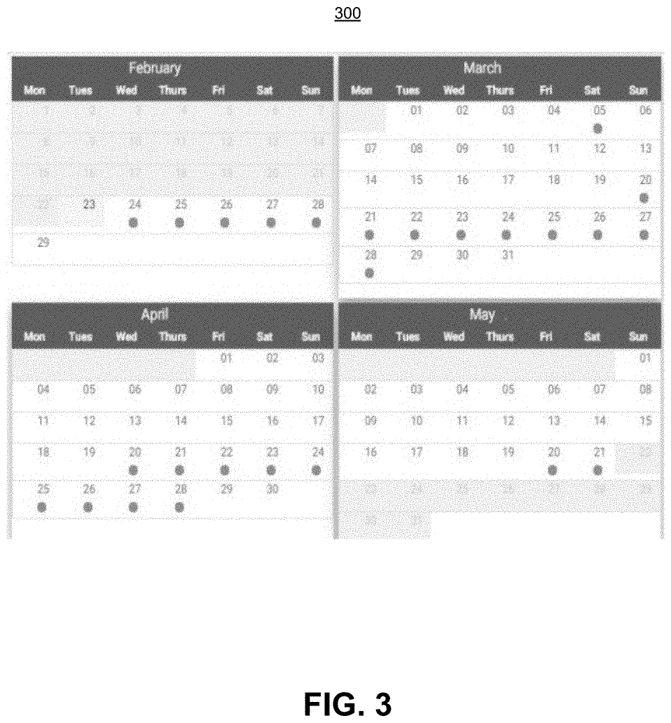

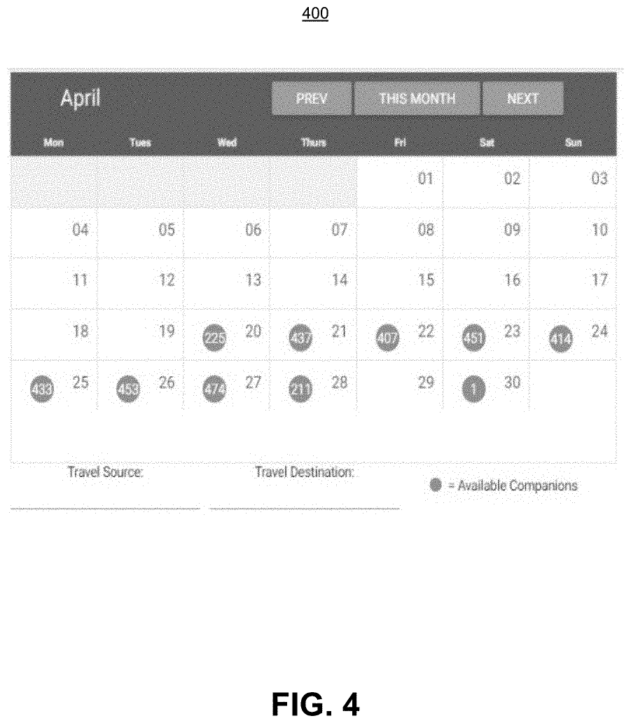

The ability to see companion availability snapshots for the next three months can be referred to herein as an “inferred context.” An end user may not be able to provide this inferred context in a traditional companion search system. For example, to achieve a similar result, a companion seeker may be required to conduct at least 90 searches (e.g., one search for each day of the three month period) and collate the results manually. By using pre-inferred context, the companion availability snapshot problem can be solved with an intuitive calendar-based interface, such as the graphical user interface (GUI) 300 shown in FIG. 3. The calendar-based view of the GUI 300 shows days over the next three months, along with a green circle or other indicator over days on which a travel companion is available. To view additional information, a user may select any one of the months displayed in the GUI 300, and the system 200 can respond by producing the GUI 400 shown in FIG. 4. In the GUI 400, for each day that a travel companion is available, a number is also shown to indicate a number of travel companions available on that day.

In some examples, more than one pre-inferred context can be combined to further refine the search system and create additional value for the end-user via superimposing the search results produced by each pre-inferred context. For example, once travel companion seekers figure out a set of possible travel start dates for their loved ones, they may start looking for the lowest airfare at various travel portals or use airline's websites. However, there is an additional complicating factor in that the lowest air-fare dates must also match with at least one of the available prospective travel companion's travel itineraries (e.g., same day at same origin city, same airlines, same flight numbers for same stop-overs etc.). Thus, there is a second pre-inferred context, and the system 200 should be able to combine travel companion availability over a period of time (e.g., three months) with the lowest airfares available. Lowest airfares now have a direct correlation with available prospective travel companions in the search system.

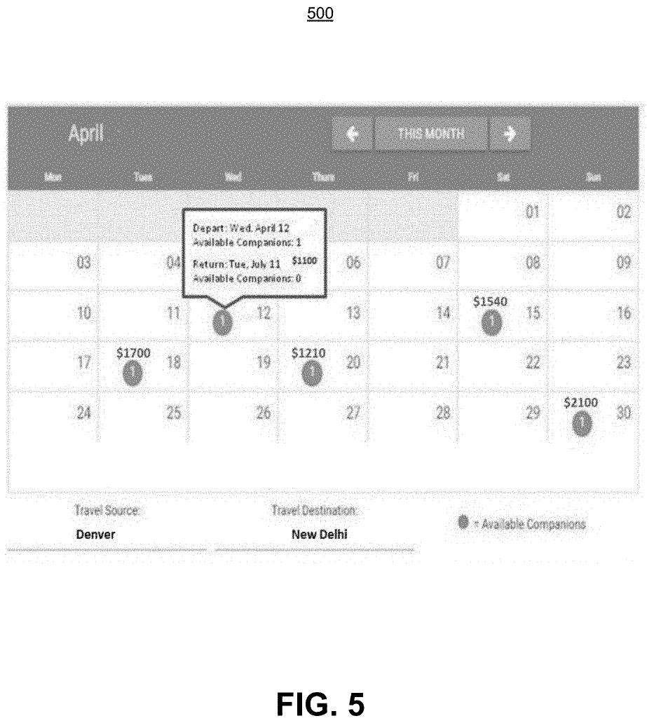

Superimposing the search results of both of these inferred contexts can result in an innovative lowest airfare and companion availability calendar, which can be provided as the GU 500 shown in FIG. 5. The GUI 500 can be similar to the GUI 400, but with the addition of airfare cost information displayed on each day for which a travel companion is available. In some implementations, a user may be able to select any day for which a travel companion is available and see additional information, such as a number of travel companions available on a desired return date. Now a companion seeker can easily find a companion with the lowest air-fare available to book an air ticket for their loved one.

To render the initial default quarterly view, such as the view shown in the GUI 300 of FIG. 3, a web application hosted by one of the virtual machines 102 can make a RESTful GET call to the back-end data management system 104. Thus, the GUI 300 can be provided to the user by one of the virtual machines 102 to allow the user to interface with the GUI 300. The processor 232 can then perform a query on the cache 220, the file system 222, the cloud storage 224, or the electronic storage 230 to retrieve the metadata about companion availability that is stored in the data management system 200. This consolidated metadata can be returned to the web application provided by the virtual machine 102, for example as a compressed JSON payload.

Subsequently, When an end-user updates the origin city and destination city filters, the web application 102 again makes a RESTful GET call to the back-end data management system 104. The processor 232 can retrieve a full list of companion itineraries and can connect to external APIs, such as Google QPX Express API and TravelFusion API, to find the lowest airfares. The lowest airfare data is consolidated with companion availability data and an updated compressed JSON payload is returned to the web application provided by the virtual machine 102. The web application can parse the JSON file and can show companion availability data alongside lowest airfare information in an intuitive calendar format to the end-user, for example via the GUI 500 of FIG. 5.

In some implementations, the data management system 104 can also collect air fare information in the background and keep it up-to-date in the cache 220. Since airfares are dynamic and change over time, airfare data may not be stored in file system 222. Thus, when the web application retrieves the companion data, the airfare data can also become part of the companion availability JSON array and the web application may not require any additional calls to get the airfare information.

Thus, in some examples, the data management system 104 periodically fetches airfare data. In some implementations, an Ajax request may also update airfare info in the cache 220. For example, polling airfare information each time directly from travel affiliate APIs and displaying it on the web application can slow down the web application. This creates the risk of showing slightly old information, however it can be assumed that airfares do not change on an hour by hour basis. In some examples, a message can be displayed to the user via web application (e.g., as part of any of the GUIs 300, 400, or 500).

In some implementations, the system 200 of FIG. 2 can be scalable such that providing the GUIs 300, 400, and 500, and manipulating data according to user interactions with the GUIs 300, 400, and 500, can be performed in an efficient manner. For example, in a given software system, a user either reads the data (e.g., read queries or GET) or inserts the data (e.g., insert/update or PUT/POST) through a user interface. Often read operations can outnumber insert operations in a given software application. Traditional software systems can use various patterns and mechanisms, such as caching at the application, web server, or browser levels, to improve the efficiency of a system. Another solution makes use of asynchronous reads (e.g., Ajax) to improve a given software system's performance. This disclosure provides techniques for using read data's optimal granularity as a basis to improve a given software system's performance, scalability, and usability. This can require upfront analysis of the user's context, as well as retrieving an optimal combination of metadata and data as part of the read operation. This can facilitate designing a user interface that displays only relevant data to the end user.

As described above, in the system 200 of FIG. 2, the web application that executes on the virtual machine 102a can allow a user to upload a travel itinerary so that the user can enlist his or her assistance to an elderly traveler who may be traveling alone. Such travelers may use the web application provided by the virtual machine 102b to search for travel companions available on a preferred travel date or range of dates.

Thus, the web application provided by the virtual machine 102a can primarily perform insertion of data into the data management system 104, and the web application provided by the virtual machine 102b can primarily retrieve information from the data management system 104 in response to search queries. As discussed above, the GUI 300 of FIG. 3 can provide an intuitive companion calendar that gives a user an overview of overall companion availability for the next few months. A calendar date marked with a green dot reflects companions available on that date. When a user opens the web application provided by the virtual machine 102b, the user can be presented with this default quarterly calendar view shown in FIG. 3. To prepare this view, the data management system 104 can present the AngularJS based web user interface with a JSON file that has a Boolean “yes” or “no” (YIN) for each date in the quarterly calendar. On the back-end, this JSON file can be prepared quickly by retrieving this data from an application cache, such as the cache 220. For example, the cache 220 can be an open source Ehcache.

As a next step, the user can select a month card to see a number of companions available on each day of the selected month, as shown in the GUI 400 of FIG. 4. The green dots can encircle the count of prospective companions starting their travel on each day. The user can select a previous or next button to go to the previous or next month's calendar. At this point the user can also to refine the search by entering preferred source and destination cities. The monthly view can then change dynamically and numbers in the green circle show companion available between the selected origin city and the selected destination city.

In some implementations, this dynamic update can be achieved without making any additional calls to the data management system 104. For example, by using the same JSON file that the web application executing on the virtual machine 102b previously retrieved from the data management system 104, the default quarterly calendar view can be populated with travel companion information.

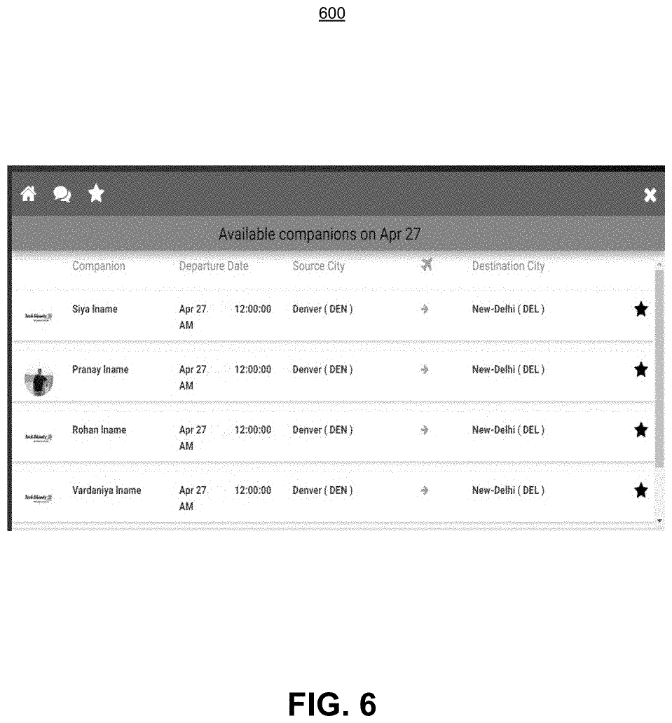

To accomplish this efficiency, the data management system 104 can include all of this data in the JSON file first returned to render the quarterly view. Initially it may seem that including companion count availability for each city pair (i.e., origin and destination) may rapidly increase the JSON payload size and reduce overall efficiency, most of this data can be metadata and by enabling data compression at the data management system 104, the overall size of metadata in the JSON payload can be reduced. At this point, the user can select an individual green circle in the monthly view shown in FIG. 5 to see a list of available companion profiles in the system between the specified source and destination city on a given date as shown in the GUI 600 of FIG. 6. To render the profile view of FIG. 6, the web application executing on the virtual machine 102b can make another call (e.g., an Ajax call) to the data management system 104 to retrieve a list of available companion profiles between a given source and destination city on a given day.

Thus, the innovative solutions provided in this disclosure can effectively use metadata to satisfy a user's contextual requirements before retrieving relevant data from the data management system 104. The GUIs 300, 400, 500, and 600 can also be designed accordingly to satisfy the user's contextual requirements with light-weight metadata before retrieving relevant data from the data management system 104. This innovative approach can lead to an enhanced end user experience and reduced load on the data management system 104, as only the relevant data is retrieved from the data management system 104 for the user. This can lead to increased efficiency in the system 200.

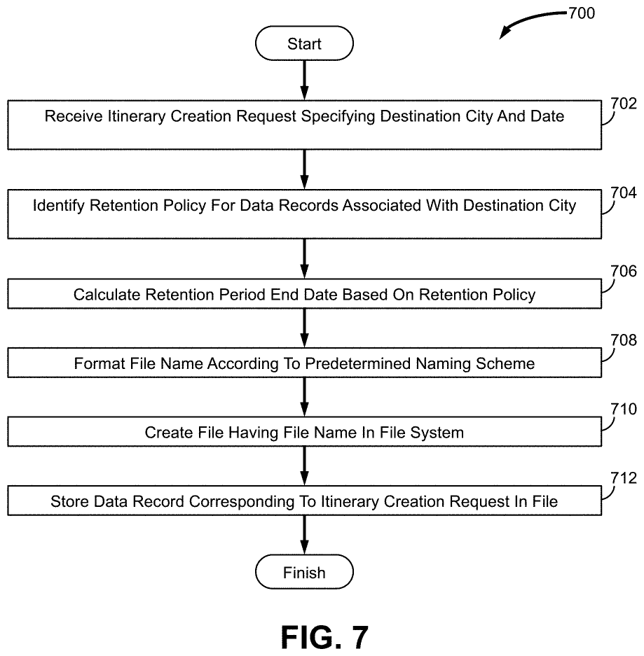

FIG. 7 illustrates a method 700 for managing data files, in accordance with one or more implementations. The operations of method 700 presented below are intended to be illustrative. In some implementations, method 700 may be accomplished with one or more additional operations not described, and/or without one or more of the operations discussed. Additionally, the order in which the operations of method 700 are illustrated in FIG. 7 and described below is not intended to be limiting,

In some implementations, method 700 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 700 in response to instructions stored electronically on an electronic storage medium. The one or more processing devices may include one or more devices configured through hardware, firmware, and/or software to be specifically designed for execution of one or more of the operations of method 700.

An operation 702 may include receiving an itinerary creation request specifying a destination city and a date. Operation 702 may be performed by one or more hardware processors configured by machine-readable instructions including a module that is the same as or similar to request management module 208, in accordance with one or more implementations.

An operation 704 may include identifying a retention policy for data records associated with the destination city. Operation 704 may be performed by one or more hardware processors configured by machine-readable instructions including a module that is the same as or similar to retention policy management module 214, in accordance with one or more implementations.

An operation 706 may include calculating a retention period end date based on the retention policy. Operation 706 may be performed by one or more hardware processors configured by machine-readable instructions including a module that is the same as or similar to retention policy management module 214, in accordance with one or more implementations.

An operation 708 may include formatting a file name according to a predetermined naming scheme. The file name may specify the destination city and the retention period end date. Operation 708 may be performed by one or more hardware processors configured by machine readable instructions including a module that is the same as or similar to file system management module 210, in accordance with one or more implementations.

An operation 710 may include creating a file having the file name in a file system. Operation 710 may be performed by one or more hardware processors configured by machine readable instructions including a module that is the same as or similar to file system management module 210, in accordance with one or more implementations.

An operation 712 may include storing a data record corresponding to the itinerary creation request in the file. Operation 712 may be performed by one or more hardware processors configured by machine-readable instructions including a module that is the same as or similar to file system management module 210, in accordance with one or more implementations.

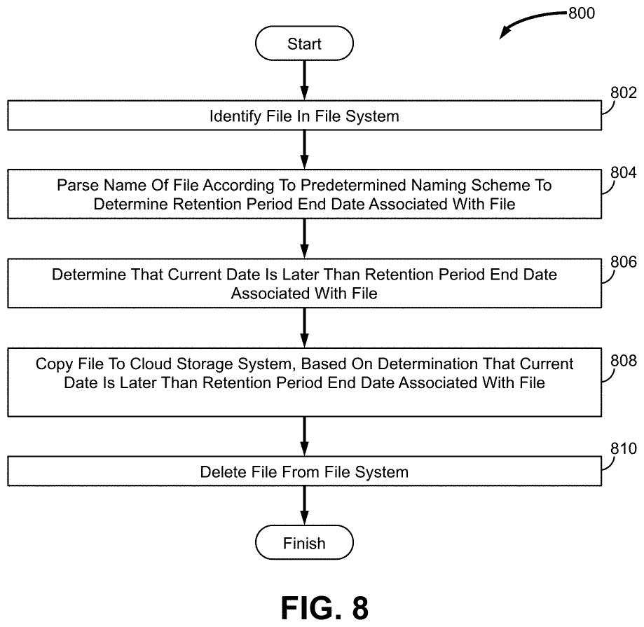

FIG. 8 illustrates a method 800 for managing data files, in accordance with one or more implementations. The operations of method 800 presented below are intended to be illustrative. In some implementations, method 800 may be accomplished with one or more additional operations not described, and/or without one or more of the operations discussed. Additionally, the order in which the operations of method 800 are illustrated in FIG. 8 and described below is not intended to be limiting.

In some implementations, method 800 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 800 in response to instructions stored electronically on an electronic storage medium. The one or more processing devices may include one or more devices configured through hardware, firmware, and/or software to be specifically designed for execution of one or more of the operations of method 800.

An operation 802 may include identifying a file in a file system. Operation 802 may be performed by one or more hardware processors configured by machine-readable instructions including a module that is the same as or similar to file system management module 210, in accordance with one or more implementations.

An operation 804 may include parsing a name of the file according to a predetermined naming scheme to determine a retention period end date associated with the file. Operation 804 may be performed by one or more hardware processors configured by machine readable instructions including a module that is the same as or similar to request management module 208, in accordance with one or more implementations.

An operation 806 may include determining that a current date is later than the retention period end date associated with the file. Operation 806 may be performed by one or more hardware processors configured by machine-readable instructions including a module that is the same as or similar to request management module 208, in accordance with one or more implementations.

An operation 808 may include copying the file to a cloud storage system, based on the determination that the current date is later than the retention period end date associated with the file. Operation 808 may be performed by one or more hardware processors configured by machine-readable instructions including a module that is the same as or similar to data cleanup module 218, in accordance with one or more implementations.

An operation 810 may include deleting the file from the file system. Operation 810 may be performed by one or more hardware processors configured by machine-readable instructions including a module that is the same as or similar to data cleanup module 218, in accordance with one or more implementations.

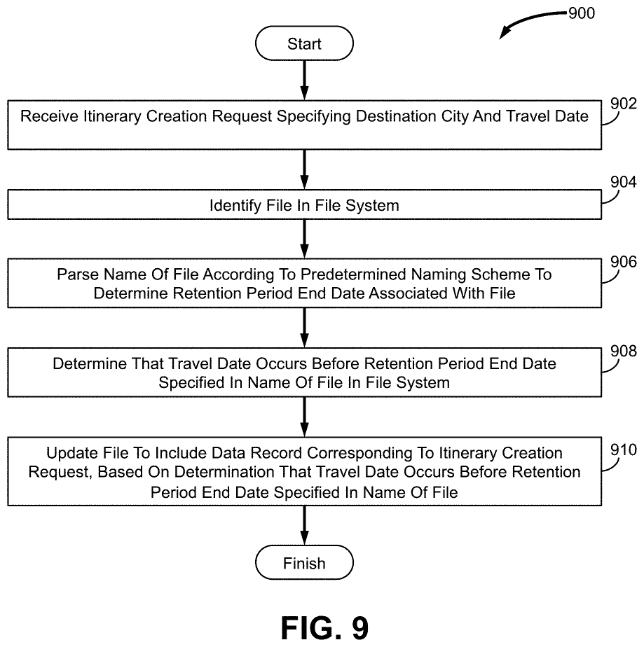

FIG. 9 illustrates a method 900 for managing data files, in accordance with one or more implementations. The operations of method 900 presented below are intended to be illustrative. In some implementations, method 900 may be accomplished with one or more additional operations not described, and/or without one or more of the operations discussed. Additionally, the order in which the operations of method 900 are illustrated in FIG. 9 and described below is not intended to be limiting.

In some implementations, method 900 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 900 in response to instructions stored electronically on an electronic storage medium. The one or more processing devices may include one or more devices configured through hardware, firmware, and/or software to be specifically designed for execution of one or more of the operations of method 900.

An operation 902 may include receiving an itinerary creation request specifying a destination city and a travel date. Operation 902 may be performed by one or more hardware processors configured by machine-readable instructions including a module that is the same as or similar to request management module 208, in accordance with one or more implementations.

An operation 904 may include identifying a file in a file system. Operation 904 may be performed by one or more hardware processors configured by machine-readable instructions including a module that is the same as or similar to file system management module 210, in accordance with one or more implementations.

An operation 906 may include parsing a name of the file according to a predetermined naming scheme to determine a retention period end date associated with the file. Operation 906 may be performed by one or more hardware processors configured by machine readable instructions including a module that is the same as or similar to request management module 208, in accordance with one or more implementations.

An operation 908 may include determining that the travel date occurs before the retention period end date specified in the name of the file in the file system. Operation 908 may be performed by one or more hardware processors configured by machine-readable instructions including a module that is the same as or similar to request management module 208, in accordance with one or more implementations.

An operation 910 may include updating the file to include a data record corresponding to the itinerary creation request, based on the determination that the travel date occurs before the retention period end date specified in the name of the file. Operation 910 may be performed by one or more hardware processors configured by machine-readable instructions including a module that is the same as or similar to file system management module 210, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for end user pre-inferred context driven applications, the system comprising:
one or more hardware processors configured by machine-readable instructions to:
Perform upfront analysis of the end user's pre-inferred context;
Retrieve end user pre-inferred context metadata and/or data as the initial read operation;
Render a user interface that displays end user pre-inferred context metadata and/or data;
Retrieve additional end user pre-inferred context metadata and/or data;
Render a superimposed user interface with additional end user pre-inferred context metadata and/or data.

2. The system of claim 1, wherein the one or more hardware processors are further configured by machine-readable instructions to retrieve end user pre-inferred context metadata and/or data from a cache as part of the initial read operation.

3. The system of claim 2, wherein the one or more hardware processors are further configured by machine-readable instructions to render a user interface with end user pre-inferred context metadata and/or data.

4. The system of claim 3, wherein the one or more hardware processors are further configured by machine-readable instructions to retrieve additional end user pre-inferred context metadata and/or data from a cache as part of the read operation.

5. The system of claim 4, wherein the one or more hardware processors are further configured by machine-readable instructions to render a superimposed user interface with additional end user pre-inferred context metadata and/or data.

6. A method for end user pre-inferred context driven applications, comprising:
Performing upfront analysis of the end user's pre-inferred context;
Retrieving end user pre-inferred context metadata and/or data as the initial read operation;
Rendering a user interface that displays end user pre-inferred context metadata and/or data;
Retrieving additional end user pre-inferred context metadata and/or data;
Rendering a superimposed user interface with additional end user pre-inferred context metadata and/or data.

7. The method of claim 6, further comprising retrieval of end user pre-inferred context metadata and/or data from a cache as part of the initial read operation.

8. The method of claim 7, further comprising rendering of a user interface with end user pre-inferred context metadata and/or data.

9. The method of claim 8, further comprising retrieval of additional end user pre-inferred context metadata and/or data from a cache as part of the read operation.

10. The method of claim 9, further comprising rendering of a superimposed user interface with additional end user pre-inferred context metadata and/or data.

11. A non-transient computer-readable storage medium having instructions embodied thereon, the instructions being executable by one or more processors to perform a method for end user pre-inferred context driven applications, the method comprising:
Performing upfront analysis of the end user's pre-inferred context;
Retrieving end user pre-inferred context metadata and/or data as the initial read operation;
Rendering a user interface that displays end user pre-inferred context metadata and/or data;
Retrieving additional end user pre-inferred context metadata and/or data;
Rendering a superimposed user interface with additional end user pre-inferred context metadata and/or data.

12. The computer-readable storage medium of claim 11, wherein the method further comprises retrieval of end user pre-inferred context metadata and/or data from a cache as part of the initial read operation.

13. The computer-readable storage medium of claim 12, wherein the method further comprises rendering of a user interface with end user pre-inferred context metadata and/or data.

14. The computer-readable storage medium of claim 13, wherein the method further comprises retrieval of additional end user pre-inferred context metadata and/or data from a cache as part of the read operation.

15. The computer-readable storage medium of claim 14, wherein the method further comprises rendering of a superimposed user interface with additional end user pre-inferred context metadata and/or data.
